(19) United States
(12) Patent Application Publication
(10) Pub. No.: US 2021/0263576 A1
(43) Pub. Date: Aug. 26, 2021

(54) POWER SOURCE DETERMINATION BASED ON POWER CONTRACTS

(71) Applicant: HEWLETT-PACKARD DEVELOPMENT COMPANY, L.P., Spring, TX (US)

(72) Inventors: Monji G. Jabori, Spring, TX (US); Qijun Chen, Spring, TX (US); Roger D. Benson, Spring, TX (US)

(73) Assignee: HEWLETT-PACKARD DEVELOPMENT COMPANY, L.P., Spring, TX (US)

(21) Appl. No.: 17/258,808

(22) PCT Filed: Nov. 13, 2018
(86) PCT No.: PCT/US2018/060837

§ 371 Date: Jan. 8, 2021

(51) Int. Cl. G06F 1/26; G06F 13/42

(52) U.S. Cl. CPC G06F 1/263; G06F 1/266; H02J 7/00032; G06F 2213/0042; G06F 13/4282

(57) ABSTRACT

According to examples, an apparatus may include a power converter and a controller. The controller may intercept a power contract negotiation between a first device and a second device, spoof the first device and the second device with respect to each other, and determine a power contract between the first device and the second device. The controller may also supply power to the first device from an external power source through the power converter according to the power contract while enabling pass-through of a communication signal between the first device and the second device through the apparatus.

### BACKGROUND

Many electronic devices, such as cellular telephones, headphones, input devices, speakers, and portable batteries, may connect to electronic apparatuses, such as laptops, tablets, personal computers, televisions, and wall sockets via input/output (I/O) port connections. For instance, the I/O ports may be Universal Serial Bus (USB) ports. Some electronic devices may receive power from the electronic apparatuses via the I/O port connections and/or may communicate data with the electronic apparatuses via the I/O port connections.

### BRIEF DESCRIPTION OF DRAWINGS

Features of the present disclosure are illustrated by way of example and not limited in the following figure(s), in which like numerals indicate like elements, in which:

FIG. 1 shows a block diagram of an example apparatus that may control a supply of power to a first device;

FIG. 2 shows a block diagram of an example system that may include the example apparatus depicted in FIG. 1;

FIG. 3 shows a block diagram of an example apparatus that may control a supply of power to a first device;

FIG. 4 shows an example method for controlling a supply of power to a first device; and

FIG. 5 shows a block diagram of an example non-transitory computer readable medium that may have stored thereon machine readable instructions that when executed by a processor, may cause the processor to supply power to a first device from a second device or an external power source.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote one of a particular element or multiple ones of the particular element. As used herein, the term “includes” means includes but not limited to, the term “including” means including but not limited to. The term “based on” may mean based in part on.

Many types of external devices, e.g., smartphones, input devices, headphones, a solid state drive, etc., that connect to a host device, e.g., a laptop, a tablet, etc., via an I/O connection, may receive power from the host device via the I/O connection. In some instances, an external device may expect a higher amount of power than the host device may provide. In these examples, the external device may not receive the expected amount of power, which may reduce or limit performance of the external device. Alternatively, the host device may supply power at the expected level, but such delivery of power may be harmful to the host device, e.g., may drain the battery of the host device at a faster rate than may be intended for the host device.

Disclosed herein are apparatuses, systems, and methods that may control a supply of power to a first device, e.g., an external device, from an external power source while enabling communications between the first device and a second device, e.g., a host device. According to examples, the apparatuses disclosed herein may function as a physical interface between the first device and the second device. In this capacity, the apparatuses may cause power to be delivered to the first device from the external power source while communicating data to the first device to make it appear that the first device is receiving power from the second device. The apparatuses may also communicate data to the second device to make it appear that the first device is either not receiving power from the second device or that the second device is supplying power to the first device. In one regard, this “spoofing” of the first device and the second device with respect to each other may cause the first device and the second device to communicate signals to each other as if the first device and the second device were connected to each other directly.

In some examples, the apparatuses may intercept data communications, e.g., power contract negotiations, between the first device and the second device. The intercepted data communications may include a requested power for the first device. In some examples, the apparatuses may cause the first device to be supplied with power according to the requested power. In some examples, the apparatuses may determine which of the second device and the external power source is to supply power to the first device. The apparatuses may make this determination based on the requested power. For instance, the apparatuses may cause power to be supplied from the second device in instances in which the requested power falls below a predefined output power level available from the second device and to cause power to be supplied from the external power source otherwise.

Through implementation of the apparatuses disclosed herein, a controller may cause an expected level of power to be supplied to a first device while also avoiding harm to the second device. Additionally, the apparatuses may control the power delivery while also enabling the first device and the second device to communicate with each other with limited or no disruption.

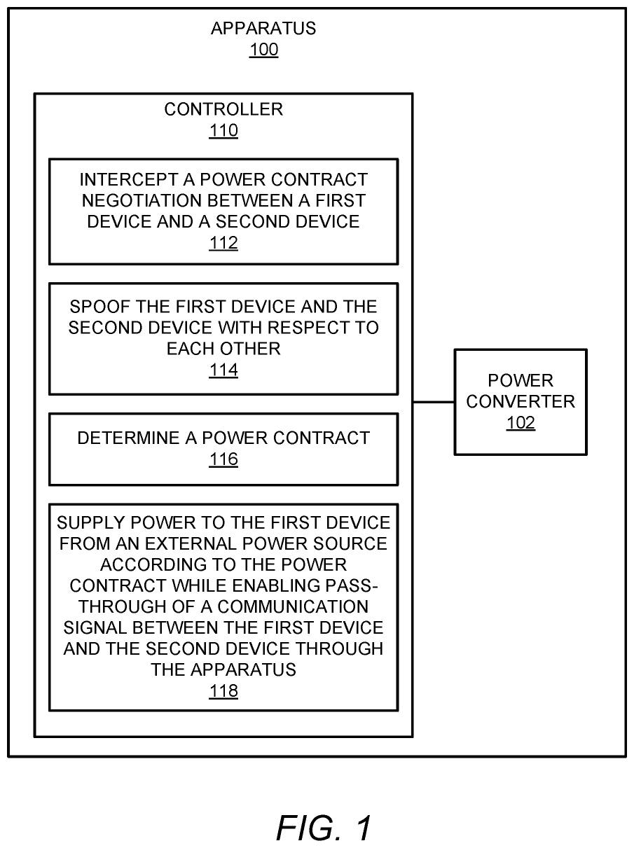

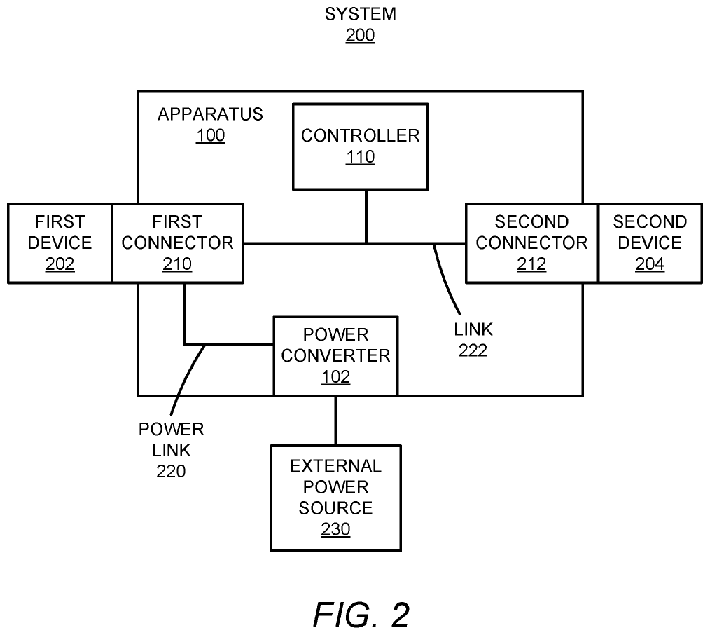

Reference is first made to FIGS. 1 and 2. FIG. 1 shows a block diagram of an example apparatus 100 that may control a supply of power to a first device. FIG. 2 shows a block diagram of an example system 200 that may include the example apparatus 100 depicted in FIG. 1. It should be understood that the example apparatus 100 and/or the example system 200 depicted in FIGS. 1 and 2 may include additional components and that some of the components described herein may be removed and/or modified without departing from the scopes of the example apparatus 100 and/or the system 200 disclosed herein.

The apparatus 100 may include a power converter 102 and a controller 110. The apparatus 100 may be an interface between a first device 202 and a second device 204. In other words, the apparatus 100 may be or may include a mezzanine daughter board to which the first device 202 and the second device 204 may respectively be connected. In any regard, the apparatus 100 may include a first connector 210 and a second connector 212. The first device 202 may be connected to the apparatus 100 via the first connector 210 and the second device 204 may be connected to the apparatus 100 via the second connector 212. Although the first device 202 and the second device 204 are depicted as being directly connected to the apparatus 100, it should be understood that the first device 202 and/or the second device 204 may be connected to the apparatus 100 via a cable or other connecting component.

In some examples, the first connector 210 may be a female port and the second connector 212 may be a male adapter. In these examples, the first device 202 may include a male adapter that may be inserted into the first connector 210 and the second device 204 may include a female port into which the second connector 212 may be inserted. In other examples, the first connector 210 may be a male adapter and the second connector 212 may be a female port. In these examples, the first device 202 may include a female port into which the first connector 210 may be inserted and the second device 204 may include a male adapter that may be inserted into the second connector 212.

Generally speaking, the first connector 210 and the second connector 212 may comply with any of a number of protocols and/or standards. For instance, the first connector 210 and the second connector 212 may comply with current and/or prior USB standards. By way of example, the first connector 210 and the second connector 212 may comply with the USB Type C standard. In other examples, the first connector 210 and the second connector 212 may comply with the Thunderbolt™ standard, the DisplayPort standard, etc. In some examples, the first connector 210 may comply with a first protocol (or a first standard) and the second connector 212 may comply with a second protocol (or a second standard). By way of example, the first connector 210 may comply with a USB standard and the second connector 212 may comply with the Thunderbolt™ standard. In these examples, the apparatus 100 may function as a converter between devices having connectors that comply with various standards.

As also shown in FIG. 2, the apparatus 100 may be connected to an external power source 230 via the power converter 102. The power converter 102 may also be connected to the first connector 210 via a power link 220, which may be a wire, conductive trace, or the like, through which an electric current may be delivered from the power converter 102 to the first connector 210. The power converter 102 may be connected to the external power source 230 and may receive power from the external power source 230 and may supply power through the power link 220. Although not shown, the controller 110 may also receive power from the power converter 102 via another link. In examples, the external power source 230 may supply an electric current to the power converter 102 and the power converter 102 may convert the electric current to a certain voltage, current, and frequency for transmission across the power link 220. The external power source 230 may be separate from the second device 204. For instance, the external power source 230 may be a wall socket, a portable battery, a third device, or the like.

As also shown in FIG. 2, the first connector 210 may be linked to the second connector 212 via a link 222. The link 222 may include a wire, a cable, a conductive trace, or the like, and may function as a communication and/or power bus. For instance, the link 222 may function as a communication and power bus over which both data signals and power may be communicated. In some examples in which the apparatus 100 functions as a converter, the apparatus 100 may include a converting component (not shown) that may intercept and convert the data signals being communicated between the first connector 210 and the second connector 212 prior to being communicated to their destinations. In some examples, the first device 202 may be a device that may receive power delivered through a connection with the first connector 210. That is, for instance, the first device 202 may be an external device that may receive power from the second device 204, which may be a host device, over the link 222.

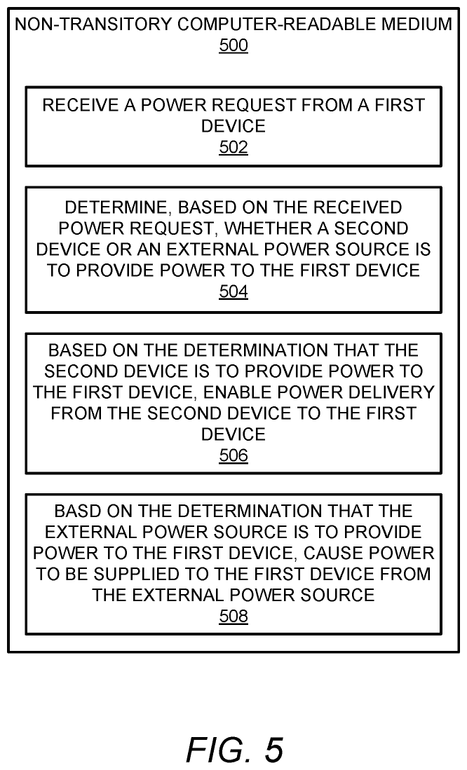

The controller 110 may be an integrated circuit, such as an application-specific integrated circuit (ASIC). In other examples, the controller 110 may operate with firmware (i.e., machine-readable instructions) stored in a memory (e.g., the non-transitory computer readable medium shown in FIG. 5). In these examples, the controller 110 may be a microprocessor, a CPU, or the like. The controller 110 may intercept (or equivalently, receive) data signals communicated over the link 222 between the first connector 210 and the second connector 212 and may execute a number of operations 112-118 based on the received data signals as discussed in detail herein. According to examples, the operations 112-118 may be instructions that the controller 110 may execute.

As shown in FIG. 1, the controller 110 may intercept 112 a power contract negotiation between the first device 202 and the second device 204. That is, the controller 110 may intercept 112 data signals communicated between the first device 202 and the second device 204 via the first connector 210 and the second connector 212 over the link 222. In some examples, for instance, during an initial communication between the first device 202 and the second device 204, the first device 202 and the second device 204 may communicate data signals corresponding to a power contract negotiation between the first device 202 and the second device 204. The power contract negotiation may include, for instance, a request by the first device 202 for power from the second device 204. The power contract negotiation may also include, for instance, a response from the second device 204 regarding whether the second device 204 is to supply power to the first device 202.

According to examples, the controller 110 may spoof 114 the first device 202 and the second device 204 with respect to each other. That is, for instance, the controller 110 may send data signals to the first device 202 as if the controller 110 was the second device 204. In addition, the controller 110 may send data signals to the second device 204 as if the controller 110 was the first device 202. As such, for instance, the second device 204 may operate as if the second device 204 was communicating with the first device 202 and the first device 202 may operate as if the first device 202 was communicating with the second device 204 even though the first device 202 and the second device 204 are communicating with the controller 110.

The controller 110 may determine 116 a power contract between the first device 202 and the second device 204. That is, for instance, the controller 110 may determine 116 the amount of power that the first device 202 has requested and may determine that the first device 202 may be supplied with the requested amount of power. In addition, the controller 110 may supply 118 power to the first device 202 from the external power source 230 according to the determined power contract. That is, for instance, the controller 110 may control the power converter 102 to supply power to the power link 220 at a current, voltage, and/or frequency as set forth in the determined power contract. In this regard, the power converter 102 may be a programmable power converter.

The controller 110 may also enable pass-through of data (or equivalently, communication) signals between the first device 202 and the second device 204 through the link 222 in the apparatus 100. That is, the controller 110 may enable the first device 202 and the second device 204 to communicate data signals, other than the power contract negotiation data signals, to each other via the link 222. In addition, the controller 110 may send a communication to the first device 202 that signals to the first device 202 that the power is supplied to the first device 202 by the second device 204. In addition, the controller 110 may send a communication to the second device 204 that signals to the second device 204 that the first device 202 is not drawing power from the second device 204. Alternatively, the controller 110 may send a communication to the second device 204 that signals to the second device 204 that the power is delivered to the first device 202 by the second device 204.

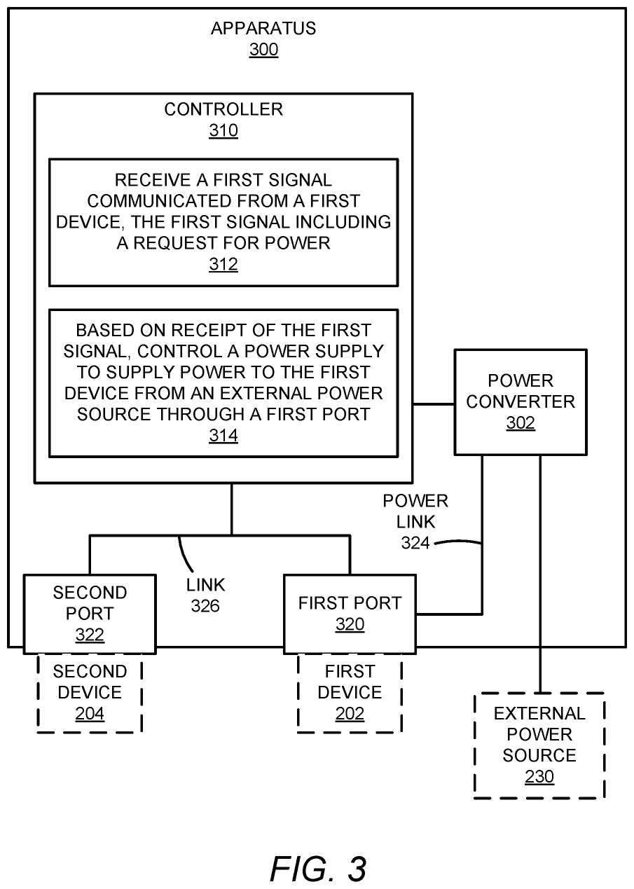

With reference now to FIG. 3, there is shown a block diagram of an example apparatus 300 that may control supply of power to a first device 202. It should be understood that the example apparatus 300 depicted in FIG. 3 may include additional components and that some of the components described herein may be removed and/or modified without departing from the scope of the example apparatus 300 disclosed herein.

The apparatus 300 may include a power converter 302, a controller 310, a first port 320, a second port 322, a power link 324, and a link 326. Similarly to the apparatus 100, the apparatus 300 may be an interface between a first device 202 and a second device 204. The apparatus 300 may be similar to the apparatus 100, the power converter 302 may be similar to the power converter 102, the controller 310 may be similar to the controller 110, the first port 320 may be similar to the first connector 210, the second port 322 may be similar to the second connector 212, the power link 324 may be similar to the power link 220, and the link 326 may be similar to the link 222 discussed above with respect to the apparatus 100. Accordingly, common features of these components will not be repeated with respect to the apparatus 300, the power converter 302, the controller 310, the first port 320, the second port 322, the power link 324, and the link 326. It is to be noted that the operations 312-314 discussed herein may be instructions that the controller 310 may execute.

As shown, the first port 320 may connect to a first device 202 and the second port 322 may connect to a second device 204. In addition, the power converter 302 may connect to an external power source 230. The first device 202, the second device 204, and the external power source 230 are shown with dashed lines to indicate that these components do not form part of the apparatus 300.

The controller 310 may be in communication with the first port 320 and the second port 322 via the link 326. In addition, the controller 310 may receive 312 a first signal communicated from the first device 202, in which the first signal may include a request for power. The controller 310 may negotiate the power contract with the first device 202. In some examples, the first device 202 may be powered, e.g., have a battery, and may send the first signal following connection to the first port 320 to initiate the power contract negotiation. In other examples, the first device 202 may not be powered and thus, when the first device 202 is connected to the first port 320, the controller 310 may cause the power converter 102 to supply power to the first port 320 over the power link 324. The first device 202, upon receiving the power, may send the first signal through the first port 320 to initiate a power contract negotiation, e.g., communicate a request for additional power.

The controller 310 may, based on receipt of the first signal, control 314 a power converter 302 to supply power to the first device 202 from the external power source 230 through the first port 320. That is, the controller 310 may control the power converter 302 to supply power to the first port 320 via the power link 324 according to a requested power level identified in the first signal. As discussed herein, the first signal may be part of a power contract negotiation and thus, the controller 310 may intercept the power contract negotiation from the first device 202. The controller 310 may also send a second signal to the second device 204, in which the second signal may be part of the power contract negotiation.

According to examples, the controller 310 may determine, from the power contract negotiation, whether the request for power from the first device 202 exceeds a predefined output power level of the second device 204. The predefined output power level may be a power level that the second device 204 is able to provide and/or a maximum output power level that the second device 204 is able to provide. The controller 310 may also control the power converter 302 to supply power to the first device 202 from the external power converter 230 based on a determination that the request from the first device 202 exceeds the predefined output power level of the second device 204. In other words, when the requested power from the first device 202 does not exceed the predefined output power level of the second device 204, the controller 310 may enable the first device 202 to receive power from the second device 204 via the link 326. However, when the requested power from the first device 202 exceeds the predefined output power level of the second device 204, the controller 310 may block the second device 204 from supplying power to the first device 202 and instead, may cause power to be delivered to the first device 202 from the external power source 230.

According to examples, the controller 310 may send a communication to the first device 202 that signals to the first device 202 that the power is supplied to the first device 202 by the second device 204. In addition, the controller 310 may send a communication to the second device 204 that signals to the second device 204 that the power is delivered to the first device 202 by the second device 204. In one regard, the communications may cause the first device 202 and the second device 204 to function as if the second device 204 is supplying power to the first device 202. As a result, the first device 202 and the second device 204 may communicate to each other normally, e.g., as if the first device 202 is directly connected to the second device 204, over the link 326.

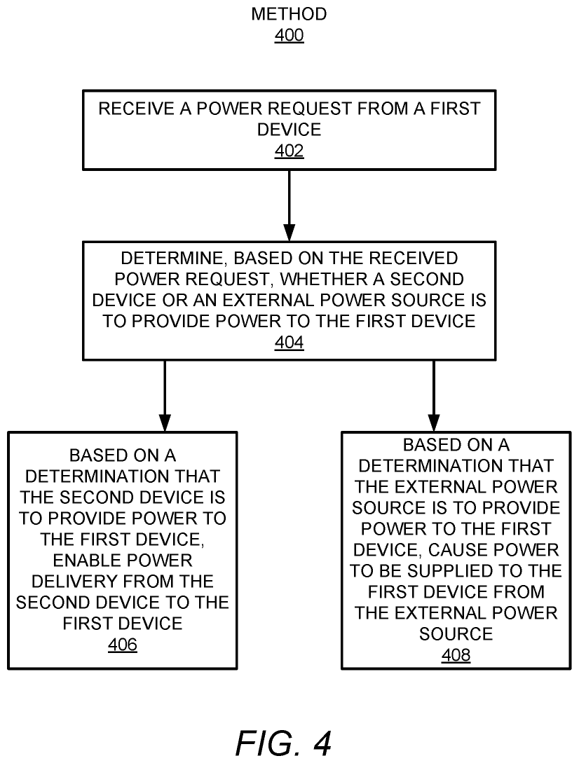

Various manners in which the apparatuses 100, 300 may be implemented are discussed in greater detail with respect to the method 400 depicted in FIG. 4. Particularly, FIG. 4 depicts an example method 400 for controlling a supply of power to a first device 202. It should be apparent to those of ordinary skill in the art that the method 400 may represent a generalized illustration and that other operations may be added or existing operations may be removed, modified, or rearranged without departing from a scope of the method 400.

The description of the method 400 is made with reference to the apparatuses 100, 300 illustrated in FIGS. 1-3 for purposes of illustration. It should be understood that apparatuses having other configurations may be implemented to perform the method 400 without departing from a scope of the method 400.

At block 402, the controller 110, 310 may receive a power request from a first device 202. At block 404, the controller 110, 310 may determine, based on the received power request, whether a second device 204 or an external power source 230 is to provide power to the first device. At block 406, the controller 110, 310 may, based on the determination that the second device 204 is to provide power to the first device 202, enable power delivery from the second device 204 to the first device 202. At block 408, the controller 110, 310 may, based on the determination that the external power source 230 is to provide power to the first device 202, cause power to be supplied to the first device 202 from the external power source 230.

According to examples, the controller 110, 310 may determine whether the received power request exceeds a predefined output power level available from the second device 204, and may determine that the second device 204 is to provide power to the first device 202 based on a determination that the received request falls below the predefined output power level available from the second device 204.

Some or all of the operations set forth in the method 400 may be contained as utilities, programs, or subprograms, in any desired computer accessible medium. In addition, some or all of the operations set forth in the method 400 may be embodied by computer programs, which may exist in a variety of forms both active and inactive. For example, they may exist as machine readable instructions, including source code, object code, executable code or other formats. Any of the above may be embodied on a non-transitory computer readable storage medium. Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Turning now to FIG. 5, there is shown a block diagram of an example non-transitory computer readable medium 500 that may have stored thereon machine readable instructions that when executed by a processor, which may be the controller 110, 310, may cause the processor to supply power to a first device 202 from a second device 204 or an external power source 230. It should be understood that the non-transitory computer readable medium 500 depicted in FIG. 5 may include additional instructions and that some of the instructions described herein may be removed and/or modified without departing from the scope of the non-transitory computer readable medium 500 disclosed herein.

The non-transitory computer readable medium 500 may have stored thereon machine readable instructions 502-508 that a processor may execute. The non-transitory computer readable medium 500 may be an electronic, magnetic, optical, or other physical storage device that contains or stores executable instructions. The transitory computer readable medium 500 may be, for example, Random Access memory (RAM), an Electrically Erasable Programmable Read-Only Memory (EEPROM), a storage device, an optical disc, and the like. The term “non-transitory” does not encompass transitory propagating signals.

The processor may fetch, decode, and execute the instructions 502 to receive a power request from a first device 202. The processor may fetch, decode, and execute the instructions 504 to determine, based on the received power request, whether a second device 204 or an external power source 230 is to provide power to the first device. The processor may fetch, decode, and execute the instructions 506 to, based on the determination that the second device 204 is to provide power to the first device 202, enable power delivery from the second device 204 to the first device 202. The processor may fetch, decode, and execute the instructions 508 to, based on the determination that the external power source 230 is to provide power to the first device 202, cause power to be supplied to the first device 202 from the external power source 230.

According to examples, the processor may determine whether the received power request exceeds a predefined output power level available from the second device 204, and may determine that the second device 204 is to provide power to the first device 202 based on a determination that the received request falls below the predefined output power level available from the second device 204.

Although described specifically throughout the entirety of the instant disclosure, representative examples of the present disclosure have utility over a wide range of applications, and the above discussion is not intended and should not be construed to be limiting but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a power converter; and
a controller to:
intercept a power contract negotiation between a first device and a second device;
spoof the first device and the second device with respect to each other;
determine a power contract between the first device and the second device; and
supply power to the first device from an external power source through the power converter according to the power contract while enabling pass-through of a communication signal between the first device and the second device through the apparatus.

2. The apparatus of claim 1, further comprising:
a first connector, wherein the first device is to connect to the apparatus via the first connector; and
a second connector, wherein the second device is to connect to the apparatus via the second connector.

3. The apparatus of claim 2, wherein the first connector and the second connector are universal serial bus connectors.

4. The apparatus of claim 1, wherein the controller is further to:
determine whether a power request from the first device exceeds a predefined output power level of the second device; and
supply power to the first device from the external power source based on a determination that the request from the first device exceeds the predefined output power level of the second device.

5. The apparatus of claim 1, wherein to spoof the first device and the second device with respect to each other, the controller is to:
send a communication to the first device that signals to the first device that the power is supplied to the first device by the second device; and
send a communication to the second device that signals to the second device that the first device is not drawing power from the second device.

6. The apparatus of claim 1, wherein the power converter is a programmable power converter to be connected to the external power source to supply power to the first device.

7. The apparatus of claim 1, wherein the power contract negotiation includes a request for power by the first device from the second device.

8. The apparatus of claim 1, wherein to spoof the first device and the second device with respect to each other, the controller is further to:
send a communication to the first device that signals to the first device that the power is supplied to the first device by the second device; and
send a communication to the second device that signals to the second device that the power is delivered to the first device by the second device.

9. An apparatus comprising:
a first port to connect to a first device;
a second port to connect to a second device
a controller in communication with the first port and the second port, the controller to:
receive a first signal communicated from the first device, the first signal comprising a request for power; and
based on receipt of the first signal, control a power converter to supply power to the first device from an external power source through the first port.

10. The apparatus of claim 9, wherein the first signal comprises part of a power contract negotiation with the first device, and wherein controller is further to:
intercept the power contract negotiation from the first device; and
send a second signal to the second device, the second signal comprising part of the power contract negotiation.

11. The apparatus of claim 10, wherein the controller is further to:
determine, from the power contract negotiation, whether the request for power from the first device exceeds a predefined output power level of the second device; and
control the power converter to supply power to the first device from the external power source based on a determination that the request from the first device exceeds the predefined output power level of the second device.

12. The apparatus of claim 10, wherein the controller is further to negotiate the power contract with the first device.

13. The apparatus of claim 9, wherein the controller is further to:
send a communication to the first device that signals to the first device that the power is supplied to the first device by the second device; and
send a communication to the second device that signals to the second device that the power is delivered to the first device by the second device.

14. A non-transitory computer-readable medium comprising machine readable instructions that when executed by a controller, cause the controller to:
receive a power request from a first device;
determine, based on the received power request, whether a second device or an external power source is to provide power to the first device;
based on the determination that the second device is to provide power to the first device, enable power delivery from the second device to the first device; and
based on the determination that the power source is to provide power to the first device, cause power to be supplied to the first device from the external power source.

15. The non-transitory computer-readable medium of claim 14, wherein the instructions are further to cause the controller to:
determine whether the received power request exceeds a predefined output power level available from the second device; and
determine that the second device is to provide power to the first device based on a determination that the received request falls below the predefined output power level available from the second device.
